(19) United States
(12) Patent Application Publication
(10) Pub. No.: US 2005/0107209 A1
(43) Pub. Date: May 19, 2005

(54) Device for controlling the torque of the drive unit of a vehicle

(76) Inventors: Nasr Nasr, Karlsruhe (DE); Thomas Moninger, Eislingen (DE)

Correspondence Address: Walter Ottesen;Patent Attorney, PO Box 4026, Gaithersburg, MD, 20885-4026, US

(21) Appl. No.: 10/502,287

(22) PCT Filed: Sep. 10, 2002
(86) PCT No.: PCT/DE02/03359

(30) Foreign Application Priority Data
Feb. 7, 2002 (DE) 102 05 024.4

(51) Int. Cl. B60K 41/04

(52) U.S. Cl. 477/107

(57) ABSTRACT

An arrangement (1) for controlling the torque of a drive unit (5) of a vehicle is suggested which increases driving comfort. The arrangement includes first means (10) which determines a desired value for the torque to be outputted by the drive unit (5). In addition, second means (15) are provided which adjusts the desired value while considering loads of the drive unit (5). This second means (15) corrects the torque, which is to be adjusted, in dependence upon the loss torques of the drive unit (5) and/or on the torque requirement of additional consumers which load the drive unit (5). The second means (15) weights first loss torques of the drive unit (5) and/or a first torque requirement of the additional consumers, which load the drive unit (5), in dependence upon motor rpm (20) and on idle rpm desired value of an idle rpm control (25) for correcting the torque to be adjusted but only when the time-dependent course of the first loss torques and/or of the first torque requirement is free of jumps during operation of the drive unit (5) or of the consumers.

### STATE OF THE ART

The invention proceeds from an arrangement for controlling the torque of a drive unit of a vehicle in accordance with the class of the main claim.

An arrangement for controlling the torque of a drive unit of a vehicle is already known from DE 43 04 779. This arrangement includes means which determine a desired value for the torque to be outputted by the drive unit. The arrangement further includes means for adjusting the pregiven desired value while considering loads of the drive unit. In addition, corrective means are provided which correct the desired value for the torque, which is to be outputted, at least in dependence upon the loss torques of the drive unit and/or the torque requirement of additional consumers loading the drive unit.

### ADVANTAGES OF THE INVENTION

The arrangement of the invention for controlling the torque of a drive unit of a vehicle having the features of the main claim has the advantage compared to the above that the second means weights the first loss torques of the drive unit and/or the first torque requirement of the additional consumers (which load the drive unit) in dependence upon an engine rpm and an idle rpm desired value of an idle rpm control to correct the torque to be adjusted and this is done only when the time-dependent course of the first loss torques and/or of the first torque requirement is free of jumps during operation of the drive unit or of the consumers. In this way, it is prevented that such loss torques or such torque requirement, whose time-dependent course during operation of the drive unit and/or of the consumer is burdened with jumps, operates over-proportionally or under-proportionally on the correction of the torque to be adjusted when there is such a jump. In this way, a reduction of comfort for the driver is substantially avoided.

Advantageous further embodiments and improvements of the arrangement set forth in the main claim are possible via the measures delineated in the dependent claims.

It is especially advantageous when the second means carries out the weighting by means of a quotient of the idle rpm desired value and the engine rpm. In this way, overshoots or undershoots of the drive unit are substantially avoided without it being necessary to activate the idle rpm control.

A further advantage results when the second means derives a weighting factor for the weighting from the second means of the quotient utilizing a characteristic line. In this way, also such loss torques and/or such torque requirement can be considered indirectly for the prevention of overshoots or undershoots of the drive unit with the time-dependent course of these loss torques and/or torque requirement being burdened with jumps during operation of the drive unit or the consumers.

A further advantage is that the second means considers second loss torques of the drive unit and/or a second torque requirement of the additional consumers (which load the drive unit) only additively to correct the torque to be adjusted when the time-dependent course of the second loss torques or the second torque requirement are burdened with jumps during operation of the drive unit and/or of the consumer, especially during shift operations. In this way, the second loss torques and/or the second torque requirement are considered weighted with the factor 1 so that jumps in the time-dependent course of the second loss torques and/or of the second torque requirement cannot operate over-proportionally or under-proportionally on the correction of the torque to be adjusted.

### DRAWING

An embodiment of the invention is shown in the drawing and is explained in detail in the following description.

FIG. 1 shows a block circuit diagram of a vehicle having an arrangement according to the invention for controlling the torque of a drive unit and

FIG. 2 shows a block circuit diagram of the arrangement of the invention.

### DESCRIPTION OF THE EMBODIMENTS

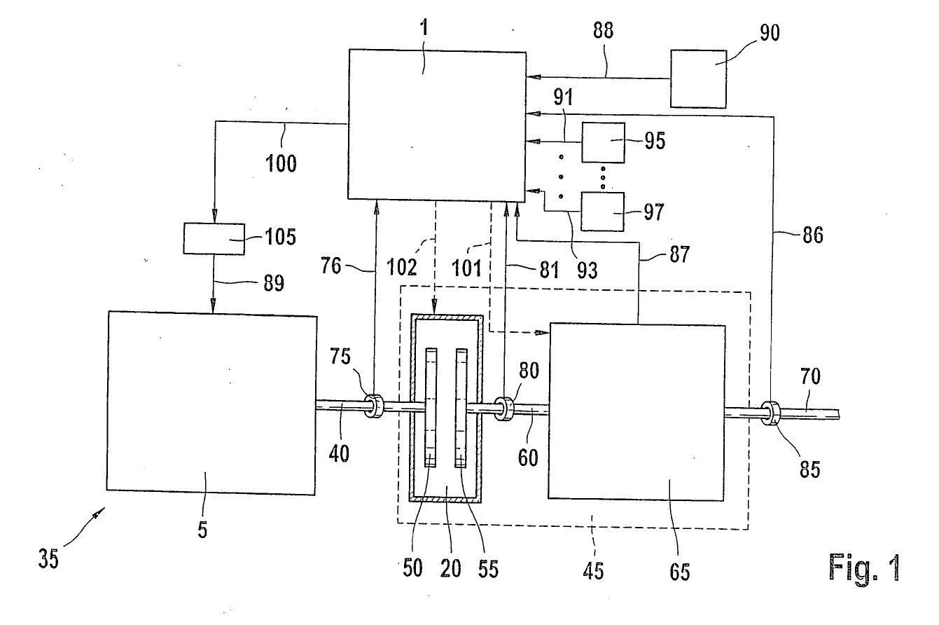

In FIG. 1, 35 identifies a vehicle of which only the elements necessary for the invention are shown for the sake of clarity. The vehicle 35 includes a drive unit 5, especially a motor. Here, the motor is preferably an internal combustion engine but, in other advantageous embodiments, the drive unit 5 can also operate on the basis of alternative drive concepts and can define, for example, an electric motor. The drive unit 5 is coupled via a shaft 40 to a converter 20 of a transmission unit 45. The first shaft 40 is, in principle, connected to a first turbine wheel 50; whereas, a second turbine wheel 55 of the converter 20 is coupled to a second shaft 60. The second shaft 60 leads to the transmission 65 whose output shaft 70 defines the output shaft of the drive train of the vehicle 35. The drive train of the vehicle 35 includes essentially the drive unit 5, the transmission unit 45 and the shafts (40, 60, 70). The following measuring devices are provided for measuring rpms. A first measuring device 75 detects the rpm of the first shaft 40 and therefore the rpm n_mot of the drive unit 5. A first connecting line 76 leads from the first measuring device 75 to an arrangement 1 according to the invention which in the following should be configured as an electronic control unit by way of example. A second measuring device 80 detects the rpm of the second shaft 60 and therefore the so-called turbine rpm n_turb of the converter 20. A second connecting line 81 connects the second measuring device 80 to the electronic control unit 1. A third measuring device 85 detects the rpm of the output shaft 70 and therewith the output rpm n_ab of the drive train. A third connecting line 86 connects the third measuring device 85 to the electronic unit 1. Furthermore, a fourth connecting line 87 leads from the transmission 65 to the electronic control unit 1. A signal Ü, which represents the transmission position, is transmitted, as required, via the fourth connecting line 87.

A fifth connecting line 88 connects the electronic control unit 1 to an operator-controlled element 90 operable by the driver of the vehicle 35. The operator-controlled element 90 can, for example, be configured as an accelerator pedal. In addition, input lines 91 to 93 are provided which connect the electronic control unit 1 to measuring devices 95 to 97 for operating variables of the drive unit 5, the drive train and/or of the vehicle 35. A line 100 symbolically defines the output lines of the electronic control unit 1 which lead to one or several actuating devices 105. These actuating devices adjust the power parameters of the drive unit 5 and this is symbolized by the sixth connecting line 89.

If the transmission unit 45 is an electronically controllable transmission having an electronically controllable converter 20, then additional output lines 101 and 102 of the electronic control unit 1 can be provided which connect the electronic control unit 1 to the transmission 65 or the converter 20 for control purposes.

The driver command is transmitted from the operator-controlled element 90 via the fifth connecting line 88 to the electronic unit 1 and the electronic control unit 1 forms from the driver command a desired value for the output torque to be outputted by the drive train for satisfying the driver command. This desired value of the output torque is converted by the electronic unit 1 via a combination of an adjustment of the transmission unit 45 as well as a torque to be outputted by the drive unit 5 to the first shaft 40. This torque is needed for making available the output torque desired value for the above adjustment of the transmission unit 45 and the combination is selected with a view to minimum fuel consumption or maximum acceleration, et cetera.

Depending upon the configuration of the transmission unit 45, the wanted adjustment is undertaken by setting a predetermined transmission ratio of the transmission 65 via the output line 101 and, if required, a control of the converter 20 via the output line 102. For making available the torque required at the output of the drive unit 5, the electronic control unit 1 computes a value for the adjustment of the power parameters of the drive unit 5 while considering the detected rpm values as well as additional operating variables of the drive unit 5 or of the drive train and/or of the vehicle 35 which operating variables are detected by the measuring devices 95 to 97. This value or these values are transmitted to the actuating device 105 via the output line 100. The actuating device 105 adjusts the pregiven power parameter values via the symbolized sixth connecting line 89. For internal combustion engines, the air supply to the internal combustion engine is regulated for adjusting power and the fuel quantity to be injected and/or the ignition angle are determined. In other embodiments, for example, in the case of an electric drive, the power parameter is the current flowing through the winding of the motor. In this case, the actuating device 105 represents the corresponding switching elements for adjusting the current flowing through the motor winding.

In the case of manually shifted transmissions, the electronic control unit 1 determines the torque for adjusting the output torque desired value by means of a characteristic field in dependence upon the driver command. This torque is to be outputted by the drive unit 5.

If this procedure according to the invention is applied in the context of an idle control without the driver command being determined and processed in the manner described above, the control of the transmission unit 45 takes place, as required, in dependence upon factors such as rpm and load. In idle operation or in operation near idle (accelerator pedal released, no overrun switchoff), an idle control is active wherein the power parameters of the motor are controlled in the sense of bringing the actual rpm close to the desired rpm.

Alternatively, the desired value for the output torque, which is to be outputted by the drive train, can also take place in the context of a drive speed control, for example, while utilizing a tempomat. For the invention, it is inconsequential from which component or control the desired value for the output torque to be outputted by the drive train is pregiven. The data provided for this purpose have only an exemplary character which should not exclude other possible applications.

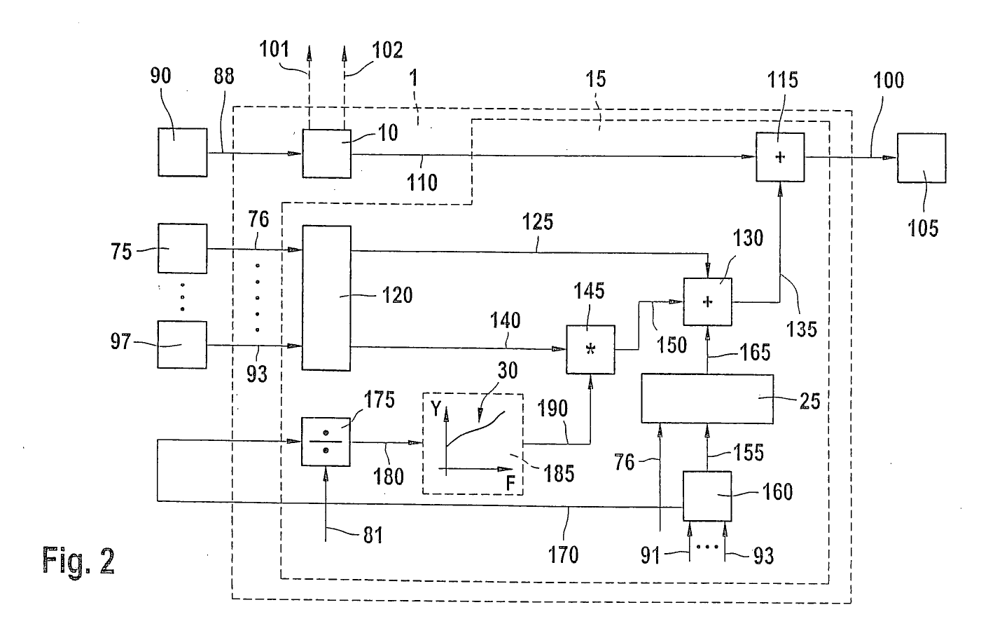

FIG. 2 shows an overview block circuit diagram of an electronic control unit 1 with a view to the procedure of the invention described hereinafter which is described based on the embodiment for an internal combustion engine without excluding other possible applications. The elements, which were already described based on FIG. 1, are identified with the same reference numerals.

The electronic control unit 1 includes first means 10 which determines the desired value for the torque to be outputted by the drive unit 5. In this embodiment, the first means 10 is connected at its input end via the fifth connecting line 88 to the operator-controlled element 90 which detects the driver command. Output lines of the first means 10 are the lines 101 and 102 for the control of the transmission 65 and the converter 20 of the transmission unit 45 and a line 110 which leads to a first logic point 115. At the output end, the first logic point 115 is connected via the output line 100 to the actuating device 105.

The procedure according to the invention is based on the below described general physical concepts. The desired value for the torque to be outputted by the drive unit 5 is transmitted on the line 110 and defines a desired value for the so-called indicated motor torque in the case of an internal combustion engine, stated otherwise, for the motor torque generated because of the combustion operation of the internal combustion engine. The motor torque, which is required for making available the desired output torque, is increased in that a portion of this motor torque is not available for driving the vehicle; instead, it is to be used for operating ancillary equipment as well as for compensating losses. For this reason, an addition of the desired value for the motor torque with the components of the loss torque and of the torque requirement of the ancillary equipment results in the first logic point 115. The components of the loss torque are instantaneous and are determined on the basis of characteristic fields. The determination of the loss torques of the drive unit 5 and the determination of the torque requirement of the ancillary equipment (which defines additional consumers loading the drive unit 5) can, for example, take place as described, for example, in DE 43 04 779 A1 which is part of this disclosure with reference to the determination of the loss torques of the drive unit 5 and of the torque requirement of the ancillary equipment.

The first logic point 115 is therefore part of the second means 15 which adjusts the desired value for the torque, which is to be outputted by the drive unit 5, while considering the loads of the drive unit. This second means 15 corrects the torque to be adjusted in dependence upon the loss torques of the drive unit 5 and/or the torque requirement of the additional consumers which load the drive unit 5. For this purpose, the second means 15 includes additionally torque detecting and evaluation means 120 which is connected at the input end via the connecting and input lines 76 to 93 to the measuring devices 75 to 97. In the manner, which is basically known from DE 43 04 779 A1, the torque detection and torque evaluation means 120 determine the loss torques of the drive unit 5 and/or the torque requirement of the ancillary equipment from the supplied measuring results of the measuring devices 75 to 97, for example, on the basis of characteristic fields. According to the invention, the torque detecting and evaluation means 120 distinguish the determined loss torques of the drive unit 5 and/or the detected torque requirement of the ancillary equipment into first loss torques and into second loss torques. The first loss torques are loss torques of the drive unit 5 and/or the first torque requirement of the additional consumers, which load the drive unit 5, whose time-dependent course is free of jumps during operation of the drive unit 5 or of the consumers. The second loss torques are loss torques of the drive unit 5 and/or the second torque requirement of the additional consumers, which load the drive unit 5, whose time-dependent course is burdened by jumps during operation of the drive unit 5 or of the consumers, especially during shifting operations. The second loss torques and/or the second torque requirement are supplied via a line 125 to a second logic point 130. At the output end, the second logic point 130 is connected via a line 135 to the first logic point 115. The first loss torques and/or the first torque requirement are supplied via a line 140 to a third logic point 145 which, at the output end, is connected via a line 150 to the second logic point 130.

Additionally, an idle rpm controller 25 is provided to which the rpm of the drive unit 5 is supplied via the first connecting line 76 and an idle rpm desired value n_des is supplied via a line 155. The idle rpm desired value n_des is formed in a computation unit 160 from operating variables of the drive unit 5 and/or of the vehicle 35 which are detected by measuring devices 95 to 97 and are supplied via lines 91 to 93. An output line 165 of the idle rpm controller 25 is likewise supplied to the second logic point 130. The determination of the idle rpm desired value n_des takes place likewise in the manner known from DE 43 04 779 A1 which, in this respect, is likewise part of this disclosure.

The idle rpm desired value n_des is supplied by the computation unit 160 on an additional output line 170 also to a fourth logic point 175. Furthermore, the turbine rpm is supplied to the fourth logic point 175 via the second connecting line 81. Here it is mentioned for the sake of clarity with respect to FIG. 2 that the use of the same reference numerals for different lines (as, for example, in the case of the first connecting line 76, the second connecting line 81 and the input lines 91 to 93) is intended to make clear that, in the case of lines having the same reference numerals, the same input quantity is supplied from the corresponding measuring device.

An output line 180 leads from the fourth logic point 175 to third means 185 for realizing a characteristic line 30. At the output end, the third means 185 is connected via a line 190 to the third logic point 145.

An addition of the input quantities is carried out in the first logic point 115. A multiplication of the input quantities is carried out in the third logic point 145. A division of the input quantities is carried out in the fourth logic point 175. The idle rpm desired value n_des is divided by the motor rpm n_mot. Via the second means 15, the loads of the drive unit 5 are considered by the loss torques of the drive unit 5 and/or by the torque requirement of additional ancillary equipment already in the form of a precontrol so that they do not later have to be compensated via the idle rpm controller 25. The torque, which is wanted by the driver and which is to be outputted by the drive unit 5, can be adjusted comparatively precisely in this manner and can be essentially adjusted in a constant manner. By considering the loads of the drive unit 5 by means of the precontrol, overshoots or undershoots in the time-dependent course of the torque, which is to be outputted by the drive unit 5, can be substantially avoided without it being necessary that the idle rpm controller 25 intervenes.

In the simplest case, the third means 185 can be omitted and the output quantity of the fourth logic point 175 can be led directly to the third logic point 145. For this reason, the third means 185 is shown in phantom outline in FIG. 2. A self-stabilization of the drive unit 5 is achieved via multiplication of the first loss torques of the drive unit 5 and/or of the first torque requirement of the ancillary equipment by the quotient of the idle rpm desired value n_des and the motor rpm n_mot in the third logic point 145, that is, by the factor F=n_des/n_mot. When the motor rpm n_mot is greater than the idle rpm desired value n_des, then the first loss torque and/or the first torque requirement is included with a factor F<1. This effects a reduced precontrol of the first loss torques and leads to a reduction of the motor rpm n_mot in the direction toward the idle rpm desired value n_des. When the motor rpm n_mot is less than the idle rpm desired value n_des, then the first loss torques and/or the first torque requirement are included with a factor F>1. This effects an increased precontrol of the losses and leads to an increase of the motor rpm n_mot in the direction toward the idle rpm desired value n_des.

Precisely in the idle point, the first loss torques and/or the first torque requirement are fully included weighted with the factor F=1 because, in this case, the motor rpm n_mot is equal to the idle rpm desired value n_des.

The weighted first loss torques and/or the weighted first torque requirement are supplied via the line 150 to the second logic point 130. The second loss torques and/or the second torque requirement are completely included without multiplication by a factor, that is, with the weighting 1 and are supplied to the second logic point 130 via the line 125. Furthermore, in the second logic point 130, the idle torque, which is requested by the idle rpm controller 25, is supplied via the line 165. In the second logic point 130, the following are added: the idle torque, which is requested by the idle rpm controller 25; the first loss torques, which are weighted by the factor F and/or the first torque requirement, which is weighted by the factor F; and, the second loss torques and/or the second torque requirement. As a sum, a requested total idle torque results which considers the loading of the drive unit 5, especially, by the loss torques of the drive unit 5 and/or the torque requirement of the ancillary equipment. The requested total idle torque is supplied via the line 135 to the first logic point 115 and is there added to the determined desired value for the torque to be outputted at the drive unit 5. The corrected desired value for the torque to be outputted by the drive unit results from addition and is outputted via the output line 100 to the actuating device 105 for realizing this corrected desired value.

In the electronic control unit 1 of the invention, with the first loss torques of the drive unit 5 and/or the first torque requirement of the ancillary equipment, only such loss torques of the drive unit 5 and/or only such a torque requirement of the ancillary equipment are weighted with the factor F whose time-dependent trace during operation of the drive unit 5 or of the ancillary equipment are free from jumps. The deliberate error made by this weighting in the inclusion of the first loss torques and/or of the first torque requirement in the requested total idle torque is taken into account in favor of the self-stabilization of the drive unit 5.

The second loss torques of the drive unit 5 and/or the second torque requirement of the ancillary equipment exhibit a time-dependent course during operation of the drive unit 5 or of the ancillary equipment, which is burdened by jumps, especially during shift operations. A weighting of the second loss torques and/or of the second torque requirement with a factor unequal to 1 would lead to an increase of the jump for F>1 or to an underevaluation of the jump for F<1 in the time-dependent course of the second loss torques and/or of the second torque requirement and could lead to a change of the torque at the drive unit 5 unexpected by the driver, primarily, when the driver undertakes no change in the accelerator pedal 90 and therefore does not expect a torque change. In this way, the driving comfort for the driver could be reduced. Therefore, the second loss torques and/or the second torque requirement are considered unweighted, that is, they are considered with the weighting 1 in the addition in the second logic point 130. Jumps in the time-dependent course of the second loss torques and/or of the second torque requirement are therefore considered undistorted in the computation of the required total idle torque in the second logic point 130. To the group of the second loss torques belong, for example, loss torques which occur in the switchover from homogeneous into stratified charge operation in a drive unit 5 having direct injection, that is, for gasoline-direct injection engines. The drive unit 5 includes a spark-ignition engine. A jump-like change of these loss torques is thereby caused primarily by a changed charge cycle work.

To the group of the second loss torques, also loss torques belong which occur for a switchoff of individual cylinders and/or individual valves of the drive unit 5. Here, for example, a jump-like time-dependent course of the second loss torques occurs when one or several cylinders are switched off. This is likewise connected to a changed charge cycle work and also with friction.

With the switchoff of cylinders, a pressure loss of the enclosed exhaust gas takes place via the piston rings in the switched-off cylinders. This occurs jump-like with the switchoff of the cylinders.

A jump-like change in the time-dependent course of the second loss torques results also in motors having an electromechanical valve drive. In concepts of this kind, each valve is operated directly via an actuator. In this way, an actuation of the valves is possible at any time. In such concepts, different advantages are achieved, for example, reduced energy consumption or increased thermodynamic efficiency via switchoff of individual cylinders and/or individual valves. The energy for driving the valves is developed by a generator whose loss torque is directly dependent upon the number of operated valves. Additionally, the charge cycle work changes during the switchoff of one or several valves whereby the sum of the changed loss torques is great and there can be corresponding jumps in the time-dependent course of the loss torques. Therefore, these loss torques likewise belong to the group of the second loss torques.

To the group of the first loss torques and/or of the first torque requirement, belong all those loss torques of the drive unit 5 and/or all that torque requirement of ancillary equipment whose time-dependent course is free of jumps during operation of the drive unit 5 or of the ancillary equipment for which also switching operations during operation do not lead to jump-like changes in the time-dependent course. To this belongs, for example, the torque requirement of an air conditioning system or of a servo pump as ancillary equipment. First loss torques can, for example, be converter losses in the converter 20 and, if required, friction power associated therewith.

The total loss torques result from the sum of the first loss torques and the second loss torques. The total torque requirement of the ancillary equipment results from the sum of the first torque requirement and the second torque requirement.

Since, according to FIG. 2, only a portion of the total losses and/or only a portion of the total torque requirement is weighted by the factor F, namely, the first loss torques and/or the first torque requirement, the above-mentioned self-stabilization of the drive unit 5 is less than when all loss torques and/or all torque requirements would be weighted by the factor F. To compensate for the absent weighting of the second loss torques and/or of the second torque requirement, the third means 185 could be optionally provided as shown in FIG. 2. The third means 185 realizes the characteristic line 30. The factor F is plotted along the abscissa. Each factor F>0 is assigned a corrective factor Y via the characteristic line 30. The trace of the characteristic line 30 is continuous or steady in order to prevent jumps and therefore an unwanted torque change for the driver. Furthermore, the ratio of Y to F for each F is greater than 1. In this way, the non-consideration of the second loss torques and/or of the second torque requirement in the weighting is again compensated. A suitable provision of data for the characteristic line 30 is required in order to prevent an overcompensation. In this way, the first loss torques and/or the first torque requirement is multiplied by the corrective factor Y in the third logic point 145 in lieu of the factor F.

Another possibility to at least partially compensate the lower self-stabilization is to include only the delta of the torque before and after the jump. Jump-like changing torques also have a known base value for which there is never a drop therebelow. This base value is calculated in weighted via the factor F. This known base value belongs therefore to the group of the first loss torques of the drive unit 5 and/or of the first torque requirement of the additional consumers loading the drive unit 5 and permits distinguishing the group of the second loss torques of the drive unit 5 and/or of the second torque requirement of the additional consumers, which load the drive unit 5, via the torque detection and evaluation means 120. Only the value which goes beyond the base value having a change in jump is calculated in unweighted whereby the component of the torques of the total loss torques, which are not weighted, becomes less and therefore the self-stabilization is increased. The value, which goes beyond the base value, with a change in jump belongs then to the group of the second loss torques of the drive unit 5 and/or of the second torque requirement of the additional consumers which load the drive unit 5.

With the separation of the loss torques of the drive unit 5 and/or of the torque requirement of ancillary equipment into the first loss torques and/or the first torque requirement on the one hand, and the second loss torques and/or the second torque requirement on the other hand, the electronic control unit 1 of the invention permits a self-stabilization of the drive unit 5 via the weighting of the first loss torques and/or of the first torque requirement. The second loss torques and/or the second torque requirement is calculated, however, especially for a jump-like change in the time-dependent course and in absolute magnitude of the jump, correctly into the required total idle torque. The described electronic control unit 1 makes possible also a self-stabilization of the drive unit 5 in the case of idle, for example, when the accelerator pedal 90 is not actuated and therefore no torque is requested by the driver and no driving stage is set. The requested total idle torque, which is supplied by the line 135 to the first logic point 115, then corresponds also to the desired value, which is to be adjusted by the actuating device 105, for the torque which is to be outputted by the drive unit 5. Also in the case of idle, a correct precontrol of the loss torques of the drive unit 5 and/or of the torque requirement of the ancillary equipment is achieved without jumps in the time-dependent course of the second loss torques and/or of the second torque requirement during operation of the drive unit 5 or of the ancillary equipment disadvantageously affecting the quality of the corresponding shifting operation and therefore the driving comfort. Jumps in the time-dependent course of the second loss torques and/or of the second torque requirement are calculated in undistorted for the determination of the requested total idle torque so that no torque change, which is unexpected by the driver, results. Accordingly, no further functional changes are necessary in order to, for example, improve the corresponding switching operation via an ignition angle shift which switch operation would lead to a jump in the time-dependent course of the second loss torques and/or of the second torque requirement during operation of the drive unit 5 or of the ancillary equipment. In this way, the complexity in the function development of the electronic control unit 1 as well as in its application to different types of drive units is reduced.

1-7. (canceled)

8. An arrangement for controlling the torque of a drive unit of a vehicle, the arrangement comprising:
first means for determining a desired value for the torque to be outputted by the drive unit;
second means for adjusting the desired value while considering loads of the drive unit;
said second means functioning to correct the torque, which is to be adjusted, in dependence upon the loss torques of the drive unit and/or on the torque requirement of additional consumers which load the drive unit; and,
said second means functioning to weight first loss torques of the drive unit and/or a first torque requirement of the additional consumers, which load the drive unit, in dependence upon motor rpm and on an idle rpm desired value of an idle rpm control for correcting the torque to be adjusted but only when the time-dependent course of the first loss torques and/or of the first torque requirement is free of jumps during operation of the drive unit or of the consumers.

9. The arrangement of claim 8, wherein said second means carries out the weighting by means of a quotient of the idle rpm desired value and the motor rpm.

10. The arrangement of claim 9, wherein said second means derives a weighting factor for the weighting from the quotient by means of a characteristic line.

11. The arrangement of claim 8, wherein said second means additively considers the weighted first loss torques and/or the weighted first torque requirement for correcting the torque to be adjusted.

12. The arrangement of claim 8, wherein said second means considers second loss torques of the drive unit and/or a second torque requirement of the additional consumers, which load the drive unit, only additively to correct the torque to be adjusted when the time-dependent course of the second loss torques and/or of the second torque requirement is burdened with jumps during operation of the drive unit or of the consumer, especially during shifting operations.

13. The arrangement of claim 12, wherein the second loss torques include loss torques which occur, for example, during a switchover from homogeneous operation into a stratified charge operation in a drive unit having direct injection including a spark-ignition engine.

14. The arrangement of claim 12, wherein the second loss torques include loss torques which occur with a switchoff of individual cylinders and/or of individual valves of the drive unit.
